(19) United States
(12) Patent Application Publication
(10) Pub. No.: US 2007/0066308 A1
(43) Pub. Date: Mar. 22, 2007

(54) Method and apparatus for removing phantom children in an ad-hoc communication system

(76) Inventors: Oleg Andric, West Palm Beach, FL (US); Vernon A. Allen, Ft. Lauderdale, FL (US); Wayne W. Chiou, Sunrise, FL (US); Ralph L. D'Souza, Sunrise, FL (US); Yan Huang, Weston, FL (US); Minh T. Pham, Boynton Beach, FL (US)

Correspondence Address: MOTOROLA, INC., 1303 EAST ALGONQUIN ROAD, IL01/3RD, SCHAUMBURG, IL, 60196, US

(21) Appl. No.: 11/219,929

(22) Filed: Sep. 6, 2005

(51) Int. Cl. H04Q 7/20

(52) U.S. Cl. 455/445

(57) ABSTRACT

A method and apparatus for removing phantom children in an ad-hoc network is described herein. During operation messaging between the parent and child nodes allows the parent node to detect when a node has become a phantom node, and take action to correct it. In particular a maintenance message is periodically transmitted by every node in the network to its parent. The maintenance message is designed to inform the parent of at least a unique identifier of the child. The parent can then compare this unique identifier of the child to others associated with the parent to determine if the child is the real child or a phantom child. Corrective action is taken when a phantom node is detected.

### FIELD OF THE INVENTION

The present invention relates generally to ad-hoc communication systems and in particular, to a method and apparatus for removing phantom children within an ad-hoc communication system.

### BACKGROUND OF THE INVENTION

Many ad-hoc communication systems are based on a cluster tree protocol, with routing being address-based. The foundation for the cluster tree topology is based on the spanning tree network design. Within an ad-hoc network based on the IEEE 802.15.4 protocol, parent nodes periodically broadcast beacons to their children nodes. The children nodes always track the parent's beacon. If the parent's beacon cannot be tracked for several consecutive frames, the child node is assumed orphaned and disconnects itself from the network. The orphaned node may then try to reconnect. A problem exists when a parent node is reset, and returns to the network under the same address or some other node takes its place with the same address without the former children being aware of the change. If the reset (e.g., power off/on) happens quickly so that its children do not notice the temporary disappearance of the parent's beacon (i.e. children do not become orphaned), the children assume they are the legitimate children of this parent and that they are part of the network, while the parent thinks it does not have any children. The parent then could accept new children assigning them the same logical addresses already given to the prior children. The prior children are then referred to as phantom children in that they believe they are still associated with the parent node, but the parent node is unaware of the assumed association. A need exists for a method and apparatus for removing phantom children in an ad-hoc network.

### BRIEF DESCRIPTION OF THE DRAWINGS

FIG. 1 is a block diagram of a communication system.

FIG. 2 is a more-detailed block diagram of the communication system of FIG. 1.

FIG. 3 illustrates a transmission scheme for the communication system of FIG. 1.

FIG. 4 illustrates a beacon transmission.

FIG. 5 is a block diagram of a node within the communication system of FIG. 1.

FIG. 6 is a flow chart showing operation of the node of FIG. 5.

### DETAILED DESCRIPTION OF THE DRAWINGS

To address the above-mentioned need, a method and apparatus for removing phantom children in an ad-hoc network is described herein. During operation messaging between the parent and child nodes allows the parent node to detect when a node has become a phantom node, and take action to correct it. In particular a maintenance message is periodically transmitted by every node in the network to its parent. The maintenance message is designed to inform the parent of at least a unique identifier of the child. The parent can then compare this unique identifier of the child to others associated with the parent to determine if the child is the real child or a phantom child. Corrective action is taken when a phantom node is detected.

Expanding on the above paragraph, when a child node associates with a parent they do so with its unique identifier (e.g. physical or IEEE address, Media Access (MAC) Address, . . . , etc.) since that is the only address it has at the time. The physical address is always an identifier that uniquely identifies the node. The physical address is stored at the parent node. The parent assigns them a logical address (e.g., an Internet Protocol (IP) address). Therefore, the parent is aware of both the logical and physical addresses of its children. If the parent receives a maintenance message from a child node, it will obtain the physical address of the child node from the message and determine whether or not the parent node has the physical address stored in memory. If so, the parent node perceives itself as the parent of the child node and may send an acknowledgment back to the child. If, however, the parent node does not find the physical address in memory, the child is assumed to be a phantom and the parent sends the child a disassociate message. The disassociate message is sent to the child's physical (e.g., IEEE) address in order to distinguish the child node from other nodes having the same logical address.

The present invention encompasses a method for removing a phantom node in a communication system. The method comprises the steps of receiving a maintenance message from a node, the maintenance message containing the node's physical address, accessing a database to determine if the node's physical address corresponds to a physical address of a child node, and if the node's physical address does not correspond to the physical address of the child node, then sending a disassociate message to the node otherwise sending an acknowledgment message.

The present invention additionally encompasses a method for removing a phantom node in a communication system. The method comprises the steps of receiving a maintenance message from a node and accessing a neighbor list to determine if the node's address corresponds to a address of a child node. The maintenance message contains a hardware address that uniquely identifies each node of a network and is unchanging. If the node's address does not correspond to the physical address of a perceived child node, then a disassociate message is sent to the node otherwise an acknowledgment message is sent.

The present invention additionally encompasses an apparatus comprising a receiver receiving a maintenance message from a node, the maintenance message containing the node's physical address. The apparatus additionally comprises logic circuitry accessing a database to determine if the node's physical address corresponds to a physical address of a child node, and a transmitter sending a disassociate message to the node if the node's physical address does not correspond to the physical address of the child node, otherwise sending an acknowledgment message.

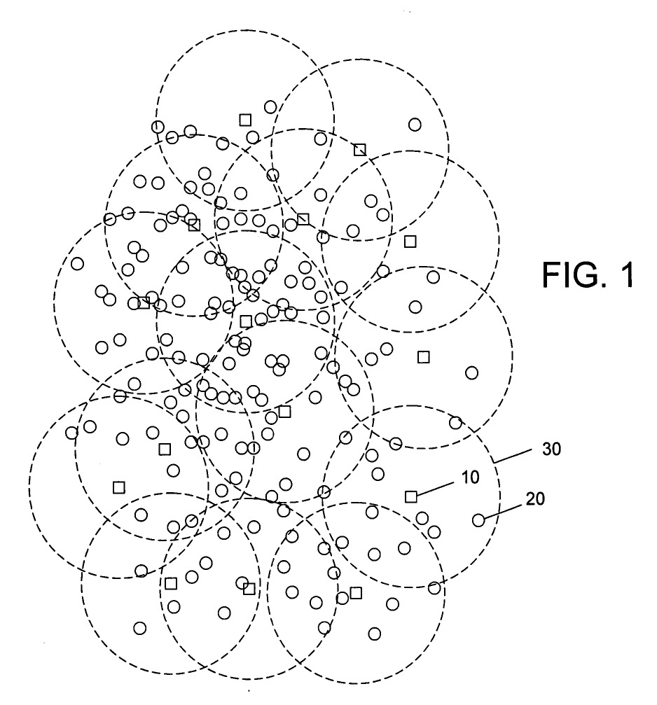

Turning now to the drawings, wherein like numerals designate like components, FIG. 1 illustrates communication system 100 in accordance with the preferred embodiment of the present invention. Communication system 100 preferably utilizes an ad-hoc communication system protocol defined by 802.15.3 Wireless Personal Area Networks for High Data Rates or IEEE 802.15.4 Low Rate Wireless Personal Area Networks. However one of ordinary skill in the art will recognize that other communication system protocols may be utilized without varying from the scope of the invention. For example, communication system 100 may utilize communication system protocols such as, but not limited to, Ad-hoc On Demand Distance Vector Routing (AODV), Dynamic Source Routing (DSR), Temporally-Ordered Routing Algorithm (TORA), Bluetooth™ standard (IEEE Standard 802.15.1), . . . , etc. As shown, communication system 100 includes a number of piconets, each comprising a coordinating device 10 and a larger number of slave nodes 20 in communication with coordinating device 10. Nodes 20 represent devices that communicate with each other through synchronization provided by coordinating devices 10. Nodes 20 can be transportable (mobile) or they can be fixed in a given place.

Prior to describing techniques for mitigating the phantom-node problem, the following definitions provide the necessary background for utilizing the techniques described below.
Physical Address: A physical address is a hardware address that uniquely identifies each node of a network and is unchanging. Such an address is usually “hard wired” into the node during its manufacture. In IEEE 802 networks, the Data Link Control (DLC) layer of the OSI Reference Model is divided into two sublayers: the Logical Link Control (LLC) layer and the Media Access Control (MAC) layer. The MAC layer interfaces directly with the network medium. Consequently, each different type of network medium requires a different MAC layer. On networks that do not conform to the IEEE 802 standards but do conform to the OSI Reference Model, the physical address may be referred to as the Data Link Control (DLC) address.”
Logical Address: A logical address is an address assigned to a device while connecting to a communication network. Such an address can be changed/reassigned in a network. In IEEE 802 networks the logical address is assigned during the ‘association’ process. In general the logical address is unique to the device assigning it (the ‘parent’ or ‘master’ device), but may be repeated when multiple networks are co-located or in an unusual circumstance like a device reset. On networks that do not conform to the IEEE 802 standards but do conform to the OSI Reference Model, the logical address may be referred to as the Logical Link Control (LLC) address.””
Orphaned Node: A node that has knowingly lost association with its parent node.
Phantom Node: A node that has unknowingly lost association with its parent node.

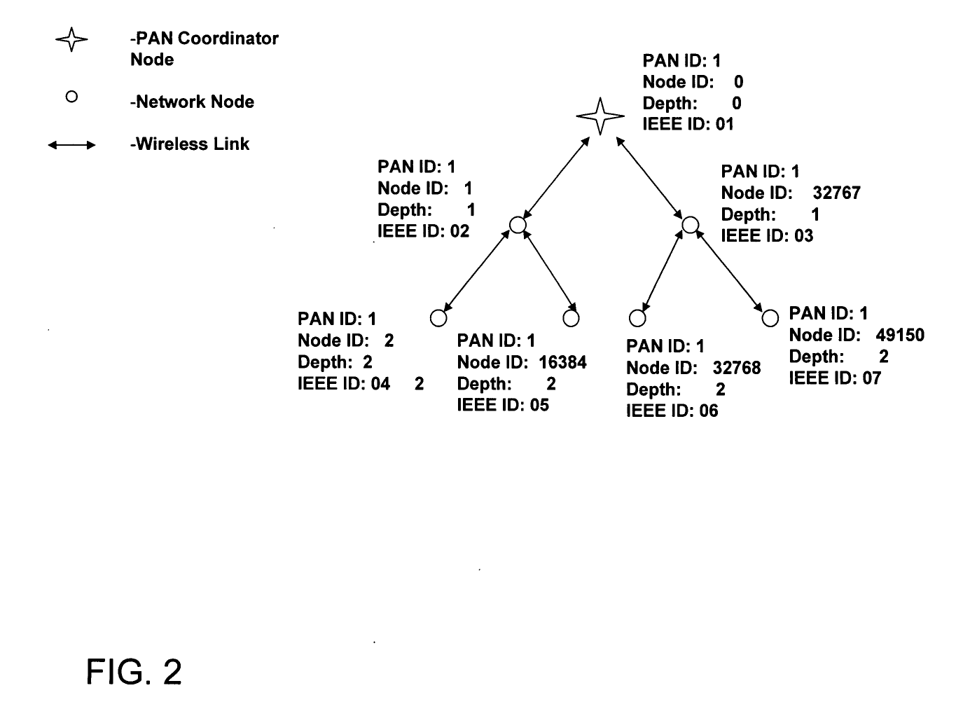

FIG. 2 is a more-detailed view of system 100, showing one coordinator and several nodes under the coordinator. The coordinator and nodes under the coordinator are typically referred to as a piconet. Within the piconet, all of the nodes send a beacon once per frame with a beacon message announcing their logical address (PAN ID and Node ID), depth, and additional optional descriptive information (for example, if it accepts children, if it is a reference node for location determination, its location coordinates, etc). The children nodes always track the parent's beacon.

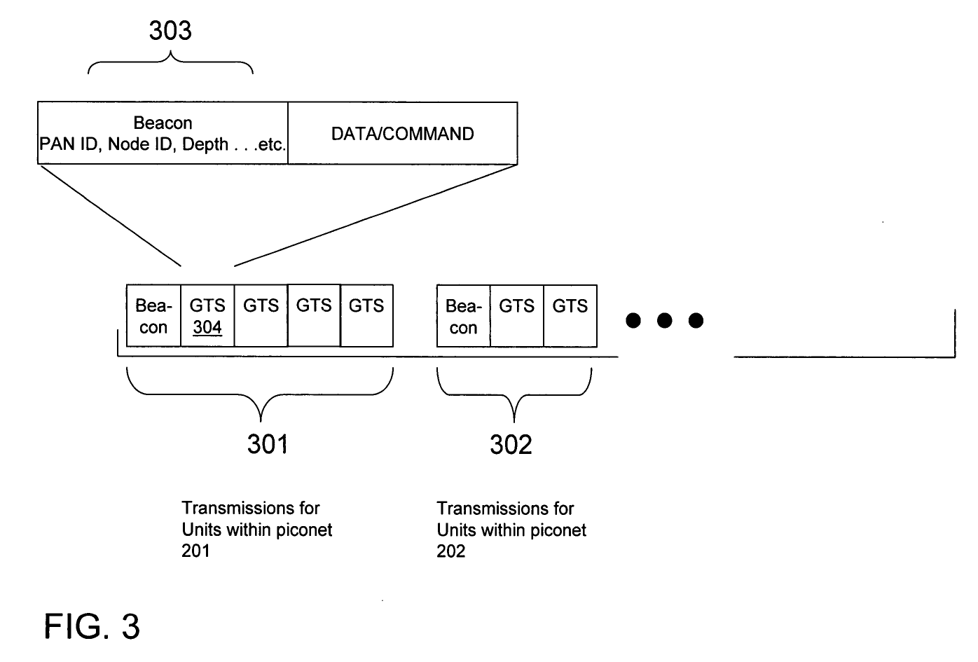

FIG. 3 illustrates a transmission scheme for the communication system of FIG. 2. During communication among nodes, a specific transmission protocol is utilized by communication system 100 wherein each piconet communicates within a particular non-overlapping superframe 301, 302 as described in U.S. patent application Ser. No. 10/414,838, which is incorporated by reference herein. With reference to FIG. 2, a first piconet completes all necessary transmissions within superframe 301, while a second piconet completes all necessary transmissions within superframe 302. During a superframe, a particular controller of the piconets will broadcast piconet timing and control information within a beacon field, while each node (including the controller) will have a Contention Free Period slot, part of the Channel Time Allocation (CTA) facility of the IEEE 802.15.3 standard, for transmission. During its guaranteed time slot, a particular node broadcasts any command (COM) wishing to be executed to any particular node or may send data intended for a single node or set of nodes. This is illustrated in FIG. 3 with the expanded view of GTS 304. One of ordinary skill in the art will recognize that the beacon signal may comprise other elements such as, but not limited to, the byte length of the frame being used, a beacon payload that can be used to broadcast generic data . . . etc.

As discussed above, a problem exists when a parent node is reset, and returns to the network under the same address or some other node takes its place with the same address without the former children being aware of the change. If the reset (power off/on) happens quickly so that its children do not notice the temporary disappearance of the parent's beacon (i.e. children do not become orphaned nodes), the children assume they are the legitimate children of this parent and that they are part of the network, while the parent thinks it does not have any children.

In order to address this issue, all nodes will periodically transmit a maintenance message to their parent node during its guaranteed time slot. The maintenance message is designed to inform the parent of at least the unique identifier of the child (e.g., a physical address). The parent then compares the unique identifier received to the unique identifiers stored in its neighbor list to determine if the child is a real child or a phantom child. Corrective action is taken when a phantom child is detected. Particularly, if the child node is perceived as a phantom, a disassociate message is sent to the phantom node causing it to disassociate with the parent node. Additionally, if the node is perceived as a legitimate child node, an acknowledgment may optionally be transmitted to the node, acknowledging receipt of the maintenance message.

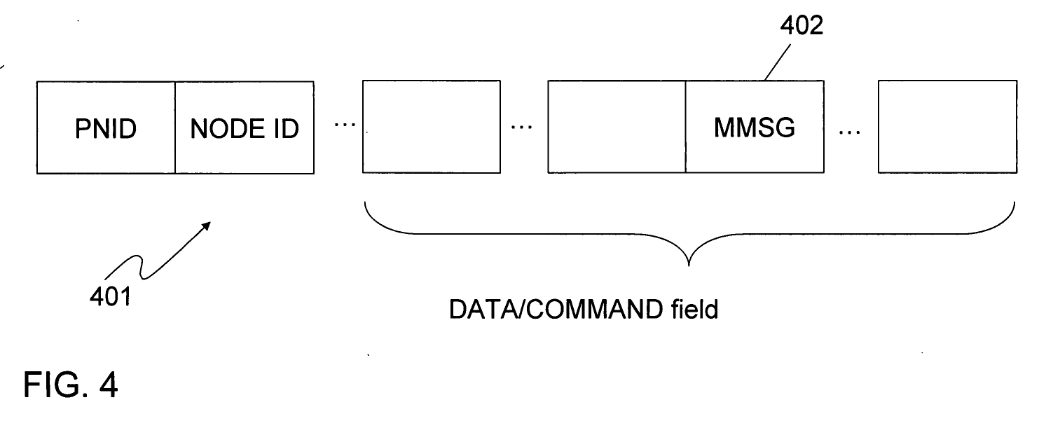

FIG. 4 illustrates beacon 401 that incorporates a maintenance message (MMSG) 402 as part of its DATA/COMMAND field to aide in determining if a node is a phantom node. The MMSG may be sent periodically (e.g., once every 5^{th} beacon), or alternatively may be sent when requested. A parent node might request from all the nodes that believe that they are its children to send their MMSGs to the node. This request results in all of the node's children (real and phantom) sending their MMSGs, causing the parent node to act on each individual MMSG with an acknowledgement or a disassociate message to real or phantom children respectively. It should be noted that the unique identifier in the MMSG is in general a node's physical address, however in certain rare cases a unique identifier might be a node's logical address if it is unique in the network. For example, a node may join the network and at that immediate time it is sure it does not have any children (it has not assigned any logical addresses to any children nodes). Therefore, any logical addresses assigned to the nodes that think they are its children are unique (since the parent node has not assign them to any real children), so these logical addresses might be considered the unique identifiers at this point of time. The parent will consider all received MMSGs to be from its phantom children since it does not have any children. Therefore, the unique identifier in this case could be the children's logical addresses.

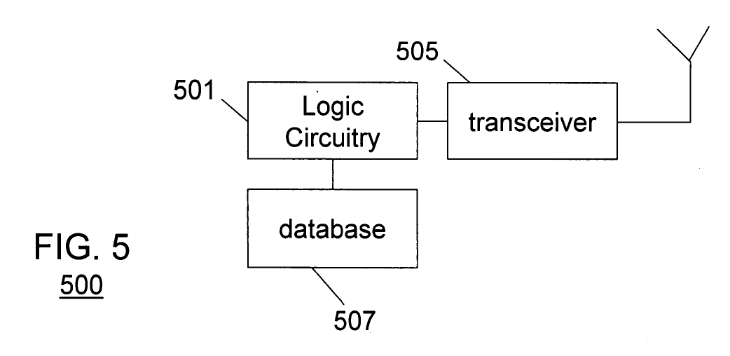

FIG. 5 is a block diagram of node 500. As is evident, node 500 comprises logic circuitry 501, transmitter/receiver (transceiver) 505, and database 507. During operation as a child node, logic circuitry 501 instructs transceiver to broadcast the maintenance message as part of its DATA/COMMAND field in its GTS. As discussed, this may be done periodically, or alternatively, may be done in response to a request to do so.

When acting as a parent node, transceiver 505 receives the maintenance message and passes this to logic circuitry 501. Logic circuitry 501 determines the physical address for the sender of the maintenance message and compares it with those stored as part of its neighbor list in database 507. More particularly, whenever a child node associates with a parent node, the parent node will create a neighbor list comprising the physical address of those nodes associated with the parent node. Thus, all child nodes in communication with a parent node will have their physical addresses located on the neighbor list. If a parent node receives a maintenance message from a child node whose physical address is not on its neighbor list, then the assumption can be that the child node is a phantom node. A disassociation message will be sent to the child node instructing them to disassociate from the parent node.

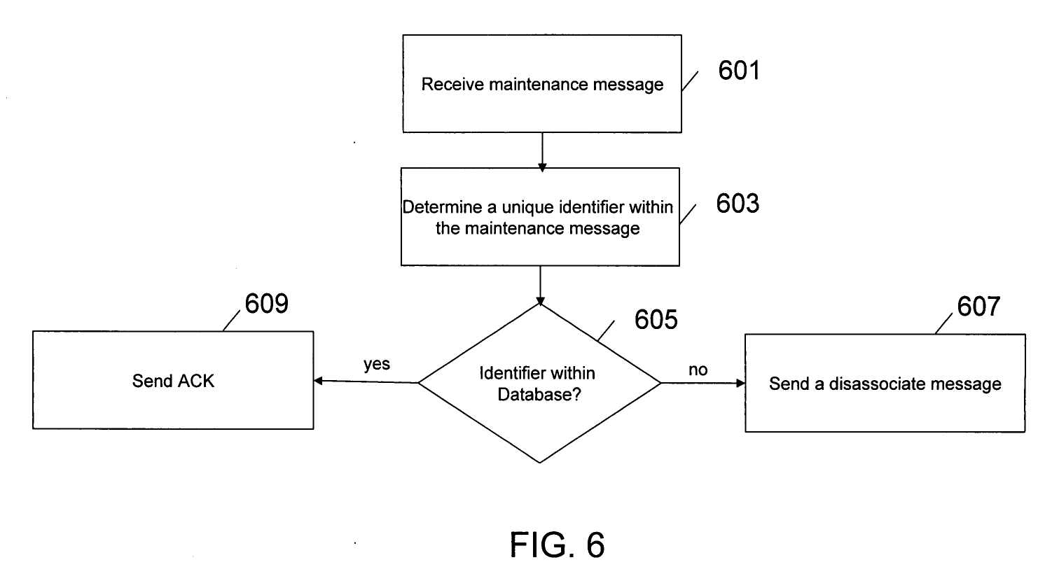

FIG. 6 is a flow chart showing operation of the node of FIG. 5 when acting as a parent node. The logic flow begins at step 601 where a maintenance message is received by transceiver 505 and passed to logic circuitry 501. At step 603, logic circuitry 501 determines a unique identifier within the maintenance message. As discussed above, the unique identifier preferably comprises a physical address of a node. At step 605 logic circuitry 501 determines if the unique identifier is contained within database 507. If not, a disassociate message is sent via transceiver 505 (step 607), otherwise an optional acknowledgment message is sent (step 609).

While the invention has been particularly shown and described with reference to a particular embodiment, it will be understood by those skilled in the art that various changes in form and details may be made therein without departing from the spirit and scope of the invention. It is intended that such changes come within the scope of the following claims.

1. A method for removing a phantom node in a communication system, the method comprising the steps of:
receiving a maintenance message from a node, the maintenance message containing the node's physical address;
accessing a database to determine if the node's physical address corresponds to a physical address of a child node; and
if the node's physical address does not correspond to the physical address of the child node, then sending a disassociate message to the node.

2. The method of claim 1 wherein the step of receiving the maintenance message comprises the step of periodically receiving the maintenance message.

3. The method of claim 1 wherein the step of receiving the maintenance message comprises the step of receiving the maintenance message as part of a guaranteed time slot.

4. The method of claim 1 wherein the physical address comprises a hardware address that uniquely identifies each node of a network and is unchanging.

5. The method of claim 1 wherein the step of accessing the database comprises the step of accessing a neighbor list.

6. The method of claim 1 wherein the maintenance message further comprises a logical address.

7. The method of claim 6 wherein the logical address comprises an address assigned to a node while connecting to a communication network and can be changed/reassigned in the network.

8. The method of claim 1 further comprising the step of:
requesting that the node send the maintenance message.

9. A method for removing a phantom node in a communication system, the method comprising the steps of:
receiving a maintenance message from a node, the maintenance message containing a hardware address that uniquely identifies each node of a network and is unchanging;
accessing a neighbor list to determine if the node's address corresponds to a address of a child node; and
if the node's address does not correspond to the physical address of a perceived child node, then sending a disassociate message to the node otherwise sending an acknowledgment message.

10. The method of claim 9 wherein the step of receiving the maintenance message comprises the step of periodically receiving the maintenance message.

11. The method of claim 9 wherein the step of receiving the maintenance message comprises the step of receiving the maintenance message as part of a guaranteed time slot.

12. The method of claim 8 wherein the maintenance message further comprises a logical address.

13. The method of claim 12 wherein the logical address comprises an address assigned to a node while connecting to a communication network and can be changed/reassigned in the network.

14. An apparatus comprising:
a receiver receiving a maintenance message from a node, the maintenance message containing the node's physical address;
logic circuitry accessing a database to determine if the node's physical address corresponds to a physical address of a child node; and
a transmitter sending a disassociate message to the node if the node's physical address does not correspond to the physical address of the child node, otherwise sending an acknowledgment message.

15. The apparatus of claim 14 wherein maintenance message is periodically received.

16. The apparatus of claim 14 wherein the maintenance message is received as part of a guaranteed time slot.

17. The apparatus of claim 14 wherein the physical address comprises a hardware address that uniquely identifies each node of a network and is unchanging.

18. The apparatus of claim 14 wherein the database comprises a neighbor list.

19. The apparatus of claim 14 wherein the maintenance message further comprises a logical address.

20. The apparatus of claim 19 wherein the logical address comprises an address assigned to a node while connecting to a communication network and can be changed/reassigned in the network.
